(19) United States
(12) Patent Application Publication
(10) Pub. No.: US 2023/0097446 A1
(43) Pub. Date: Mar. 30, 2023

(54) METHODS AND APPARATUSES FOR MANAGING NETWORK SECURITY USING VIDEO SURVEILLANCE AND ACCESS CONTROL SYSTEM

(71) Applicant: Johnson Controls Tyco IP Holdings, LLP, Milwaukee, WI (US)

(72) Inventors: Lipphei ADAM, Nolensville, TN (US); George MARTINEZ, Boca Raton, FL (US); Martin A. RENKIS, Nashville, TN (US); Alexis Brooke EHRLICH, Boca Raton, FL (US); Jason M. OUELLETTE, Sterling, MA (US)

(21) Appl. No.: 17/490,752

(22) Filed: Sep. 30, 2021

(51) Int. Cl. G07C 9/00

(52) U.S. Cl. CPC G07C 9/00309; G07C 2009/00769; G07C 2009/00365

(57) ABSTRACT

Aspects of the present disclosure include methods and systems for receiving, from a requester, a request for accessing an access-controlled asset based on authentication information of an authorized user, identifying a request location of the request, identifying a current location of the authorized user, determining whether the request location is substantially identical to the current location, and granting the request in response to authenticating the authentication information and determining that the request location is substantially identical to the current location, or denying the request in response to failure to authenticate the authentication information or determining that the request location is different than the current location.

### BACKGROUND

In a secure environment of an organization, access-controlled assets may require authorized users to provide authentication information prior to granting the authorized users access to the assets. Examples of authentication information may include user names, passwords, key fobs, access cards, and/or personal identification numbers (PINs). However, authentication information may be stolen by unauthorized users seeking to gain access to the assets. Further, an authorized user may share his or her authentication information with one or more unauthorized users without the approval of the organization. Consequently, it may be difficult to prevent unauthorized users from accessing the access-controlled assets. Therefore, improvements may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include methods and systems for receiving, from a requester, a request for accessing an access-controlled asset based on authentication information of an authorized user, identifying a request location of the request, identifying a current location of the authorized user, determining whether the request location is substantially identical to the current location, and granting the request in response to authenticating the authentication information and determining that the request location is substantially identical to the current location, or denying the request in response to failure to authenticate the authentication information or determining that the request location is different than the current location.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for managing network security using video surveillance and access control system in accordance with aspects of the present disclosure;

FIG. 2 illustrates an example method for managing network security using video surveillance and access control system in accordance with aspects of the present disclosure; and

FIG. 3 illustrates an example of a computer system in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

In some aspects of the present disclosure, a security system may control access to an access-controlled asset. The security system may require a requester to provide authentication information belonging to an authorized user, such as the login, password, personal identification number (PIN), access card, and/or key fob, to access the access-controlled asset. The requester may provide the authentication information to gain access to the access-controlled asset. The security system may determine the location of the request and the location of the authorized user. If the location of the request and the location of the authorized user are substantially identical (i.e., the requester is an authorized user), then the security system may grant the requester access to the access-controlled asset. However, if the location of the request and the location of the authorized user are not substantially identical (i.e., the requester is not an authorized user), then the security system may deny access to the request.

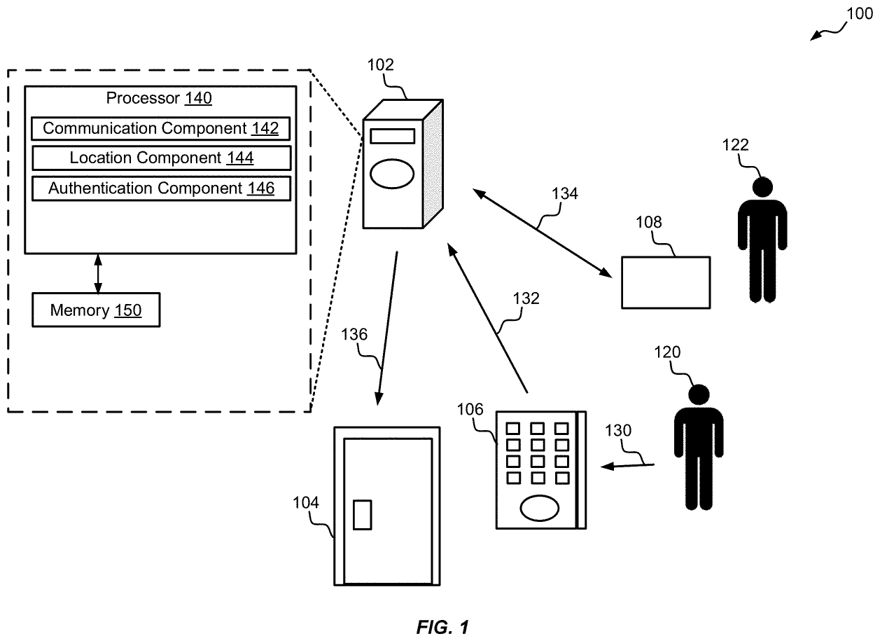

Referring to FIG. 1, in a non-limiting implementation, an example of an environment 100 for managing network security using video surveillance and access control system is shown according to aspects of the present disclosure. The environment 100 may include a security device 102. The environment 100 may include an access-controlled asset 104. The security device 102 may control access to the access-controlled asset 104. The environment 100 may include an authentication device 106 configured to receive authentication information 130 from a requester 120 for accessing the access-controlled asset 104. The authentication information 130 may including authentication information belonging to an authorized user 122. The environment 100 may include a location identification device 108 configured to identify the location of the authorized user 122.

Still referring to FIG. 1, in an aspect of the present disclosure, the security device 102 may include a processor 140 that executes instructions stored in a memory 150 for performing the functions described herein.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, controllers, digital signal processors (DSPs), field programmable gate arrays (FPGAs), programmable logic devices (PLDs), state machines, gated logic, discrete hardware circuits, and other suitable hardware configured to perform the various functionality described herein. The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

In some aspects, the security device 102 may include memory 150. The memory 150 may include software instructions and/or hardware instructions. The processor 140 may execute the instructions to implement aspects of the present disclosure.

In certain aspects, the processor 140 may include a communication component 142 configured to communicate with external devices via one or more wired and/or wireless connections. The processor 140 may include a location component 144 configured to identify the locations of the request and/or the authorized user 122. The processor 140 may include an authentication component 146 configured to authenticate an access request based on authentication information 130 provided by the requester 120.

In some aspects, the access-controlled asset 104 may be an entrance and/or exit to an infrastructure (not shown), a safe, a cabinet, a computing device, a software, a digital file, an elevator, and/or any other tangible or intangible assets. The authentication device 106 may be a reader configured to read a keycard or a key fob, an alphanumeric keypad configured to provide an interface for the requester 120 to input login, password, and/or PIN of the authorized user 122, and/or other suitable devices configured to receive the authentication information 130 from the requester 120.

In certain aspects, the location identification device 108 may be a camera configured to capture a face, gait, profile, or other features of the authorized user 122 and/or the requester 120. The location identification device 108 may be a biometric scanner configured to capture and/or analyze the iris, fingerprint, voice, and/or other biometric information of the authorized user 122 and/or the requester 120.

During operation, the requester 120 may provide the authentication information 130 to the authentication device 106 to gain access to the access-controlled asset 104. The authentication device 106 may transmit a request signal 132 containing at least some of the authentication information 130 to the security device 102. Upon receiving the request signal 132 to access the access-controlled asset 104, the security device 102 may attempt to verify that the requester 120 is the same person as the authorized user 122. The security device 102 may identify the location of the access request and/or the requester 120 based on, for example, the location of the authentication device 106 and/or the location of the access-controlled asset 104. Next, the security device 102 may communicate 134 with the location identification device 108 to obtain location information of the authorized user 122 and/or the requester 120. For example, the location identification device 108 may capture images of the requester 120 and compare the captured images with registered images of the authorized user 122. If the security system 120 determines that the location of the access request is substantially identical (e.g., within a threshold distance, in the same room of a building, in the same building, etc.), the security system 120 may determine that the authorized user 122 is the same person as the requester 120. Consequently, the security system 120 may transmit an authorization signal 136 to the access-controlled asset 104 to grant (e.g., unlock) access to the requester 120.

In a first example according to aspects of the present disclosure, the requester 120 (e.g., the same person as the authorized user 122) may input the authentication information 130, such as the login and the password of the authorized user 122, into the authentication device 106, such as an alphanumeric keyboard, to request access to the access-controlled asset 104, such as a bank vault. The location identification device 108, such as a camera placed above the bank vault (e.g., 1 meter above the alphanumeric keyboard), may capture the face of the requester 120. The location identification device 108 may communicate 134 with the security device 102 by transmitting the capture image of the face to the security device 102. The security device 102 may compare captured facial image with a stored image of the authorized user 122, and confirm that the location of the authorized user 122 (e.g., the authorized user 122 is the requester 120, who is near (e.g., less than 5 meters) the authentication device 106) is substantially identical to the location of the access request (e.g., at the authentication device 106). Therefore, the security device 102 may confirm that the requester 120 is the same as the authorized user 122, and authorize the access request to the bank vault.

In a second example according to aspects of the present disclosure, the requester 120 (e.g., an unauthorized person that stole an access keycard from the authorized user 122) may provide the authentication information 130, such as the stolen access keycard of the authorized user 122, to the authentication device 106, such as a keycard reader, to request access to the access-controlled asset 104, such as a laptop computer. The security device 102 may determine that the location of the request is the laptop computer. The security device 102 may communicate 134 with the location identification device 108, such as a camera on the laptop computer, to capture the face of the requester 120. The security device 102 may determine that the location of the authorized user 122 is not at the laptop because the captured image of the face of the requester 120 is different from the stored image of the authorized user 122. Therefore, the security device 102 may reject the access request to the laptop computer.

In a third example according to aspects of the present disclosure, the requester 120 (e.g., a unauthorized co-worker that is given the PIN of the authorized user 122 by the authorized user 122) may input the authentication information 130, such as the PIN, into the authentication device 106, such as an alphanumeric keyboard, to request access to the access-controlled asset 104, such as a digital file on a server computer. The security device 102 may determine that the location of the request is the server. The security device 102 may communicate 134 with the location identification device 108, such as a biometric scanner of the server room hosting the server computer, to determine whether the authorized user 122 has entered the server room (e.g., by presenting fingerprint, iris, and/or voice to biometric verification). The security device 102 may determine that the location of the authorized user 122 is not in the server room because there is no record of the authorized user 122 entering the server room. Therefore, the security device 102 may reject the access request to the digital file on the server computer.

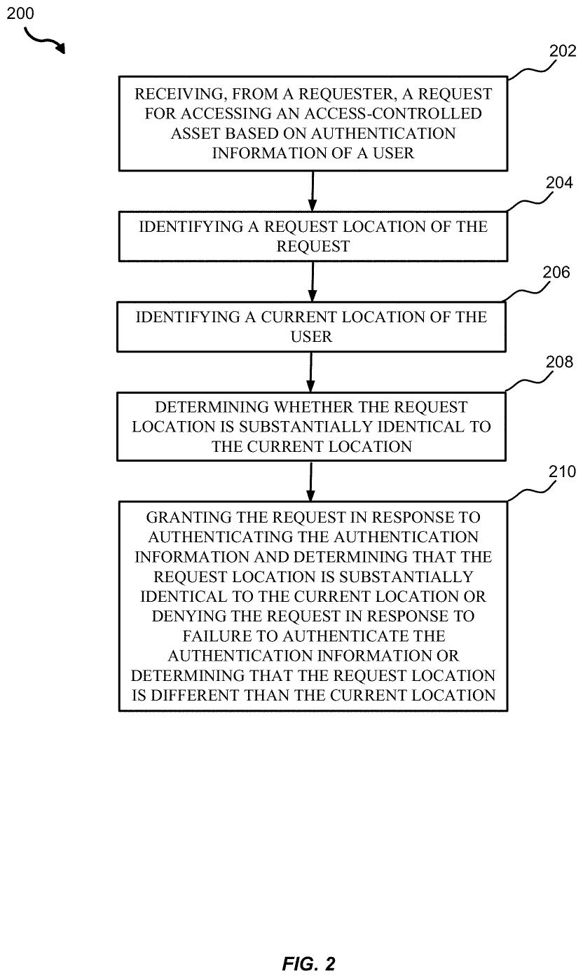

Turning to FIG. 2, an example of a method 200 for managing network security using video surveillance and access control system may be implemented by the security device 102, the authentication device 106, the location identification device 108, the processor 140, the communication component 142, the location component 144, the authentication component 146, and/or the memory 150.

At block 202, the method 200 may receive, from a requester, a request for accessing an access-controlled asset based on authentication information of a user. For example, the security device 102, the authentication device 106, the processor 140, the communication component 142, and/or the authentication component 142, and/or the memory 150 may receive a request for accessing the access-controlled asset 104 based on the authentication information 130 of the authorized user 122. The security device 102, the authentication device 106, the processor 140, the communication component 142, and/or the authentication component 142, and/or the memory 150 may be configured to and/or define means for receiving a request for accessing an access-controlled asset based on authentication information of a user.

At block 204, the method 200 may identify a request location of the request. For example, the security device 102, the authentication device 106, the processor 140, the communication component 142, the location component 144, and/or the memory 150 may identify a request location of the request. The security device 102, the authentication device 106, the processor 140, the communication component 142, the location component 144, and/or the memory 150 may be configured to and/or define means for identifying a request location of the request.

At block 206, the method 200 may identify a current location of the user. For example, the security device 102, the location identification device 108, the processor 140, the communication component 142, the location component 144, and/or the memory 150 may identify a current location of the authorized user 122. The security device 102, the location identification device 108, the processor 140, the communication component 142, the location component 144, and/or the memory 150 may be configured to and/or define means for identifying a current location of the user.

At block 208, the method 200 may determine whether the request location is substantially identical to the current location. For example, the security device 102, the authentication device 106, the location identification device 108, the processor 140, the communication component 142, the location component 144, the authentication component 146, and/or the memory 150 may determine whether the request location is substantially identical to the current location. The security device 102, the authentication device 106, the location identification device 108, the processor 140, the communication component 142, the location component 144, the authentication component 146, and/or the memory 150 may be configured to and/or define means for determining whether the request location is substantially identical to the current location.

At block 210, the method 200 may grant the request in response to authenticating the authentication information and determining that the request location is substantially identical to the current location or deny the request in response to failure to authenticate the authentication information or determining that the request location is different than the current location. For example, the security device 102, the processor 140, the communication component 142, the authentication component 146, and/or the memory 150 may grant the request in response to authenticating the authentication information and determining that the request location is substantially identical to the current location or deny the request in response to failure to authenticate the authentication information or determining that the request location is different than the current location. The security device 102, the processor 140, the communication component 142, the authentication component 146, and/or the memory 150 may be configured to and/or define means for granting the request in response to authenticating the authentication information and determining that the request location is substantially identical to the current location or denying the request in response to failure to authenticate the authentication information or determining that the request location is different than the current location.

Aspects of the present disclosure may include the method above, further comprising, prior to receiving the request, receiving a registration request to register the user and the authentication information of the user for accessing the security system.

Aspects of the present disclosure may include any of the methods above, wherein identifying the current location of the user comprises receiving at least one of a visual confirmation of the user at the current location or a biometric confirmation of the user at the current location.

Aspects of the present disclosure may include any of the methods above, wherein the authentication information include at least one of a login, a password, a key card, a key fob, or a personal identification number.

Aspects of the present disclosure may include any of the methods above, further comprising, after granting the request, detecting the user being absent from the current location and suspending or terminating access to the access-controlled asset.

Aspects of the present disclosure may include any of the methods above, further comprising, after suspending the access for a threshold period, terminating the access.

Aspects of the present disclosure may include any of the methods above, further comprising receiving a multifactor authentication, wherein granting the request further comprises of validating the multifactor authentication.

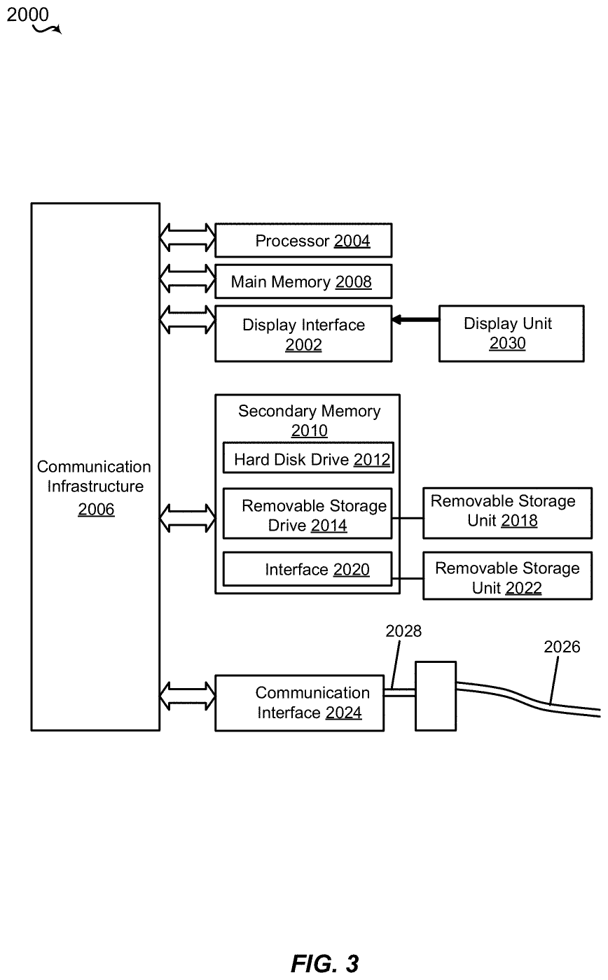

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 2000 is shown in FIG. 3. In some examples, the security device 102, the imaging device 104, and/or the security device 102 may be implemented as the computer system 2000 shown in FIG. 3. The security device 102, the imaging device 104, and/or the security device 102 may include some or all of the components of the computer system 2000.

The computer system 2000 includes one or more processors, such as processor 2004. The processor 2004 is connected with a communication infrastructure 2006 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 2000 may include a display interface 2002 that forwards graphics, text, and other data from the communication infrastructure 2006 (or from a frame buffer not shown) for display on a display unit 2030. Computer system 2000 also includes a main memory 2008, preferably random access memory (RAM), and may also include a secondary memory 2010. The secondary memory 2010 may include, for example, a hard disk drive 2012, and/or a removable storage drive 2014, representing a floppy disk drive, a magnetic tape drive, an optical disk drive, a universal serial bus (USB) flash drive, etc. The removable storage drive 2014 reads from and/or writes to a removable storage unit 2018 in a well-known manner. Removable storage unit 2018 represents a floppy disk, magnetic tape, optical disk, USB flash drive etc., which is read by and written to removable storage drive 2014. As will be appreciated, the removable storage unit 2018 includes a computer usable storage medium having stored therein computer software and/or data. In some examples, one or more of the main memory 2008, the secondary memory 2010, the removable storage unit 2018, and/or the removable storage unit 2022 may be a non-transitory memory.

Alternative aspects of the present disclosures may include secondary memory 2010 and may include other similar devices for allowing computer programs or other instructions to be loaded into computer system 2000. Such devices may include, for example, a removable storage unit 2022 and an interface 2020. Examples of such may include a program cartridge and cartridge interface (such as that found in video game devices), a removable memory chip (such as an erasable programmable read only memory (EPROM), or programmable read only memory (PROM)) and associated socket, and the removable storage unit 2022 and the interface 2020, which allow software and data to be transferred from the removable storage unit 2022 to computer system 2000.

Computer system 2000 may also include a communications circuit 2024. The communications circuit 2024 may allow software and data to be transferred between computer system 2000 and external devices. Examples of the communications circuit 2024 may include a modem, a network interface (such as an Ethernet card), a communications port, a Personal Computer Memory Card International Association (PCMCIA) slot and card, etc. Software and data transferred via the communications circuit 2024 are in the form of signals 2028, which may be electronic, electromagnetic, optical or other signals capable of being received by the communications circuit 2024. These signals 2028 are provided to the communications circuit 2024 via a communications path (e.g., channel) 2026. This path 2026 carries signals 2028 and may be implemented using wire or cable, fiber optics, a telephone line, a cellular link, an RF link and/or other communications channels. In this document, the terms “computer program medium” and “computer usable medium” are used to refer generally to media such as the removable storage unit 2018, a hard disk installed in hard disk drive 2012, and signals 2028. These computer program products provide software to the computer system 2000. Aspects of the present disclosures are directed to such computer program products.

Computer programs (also referred to as computer control logic) are stored in main memory 2008 and/or secondary memory 2010. Computer programs may also be received via communications circuit 2024. Such computer programs, when executed, enable the computer system 2000 to perform the features in accordance with aspects of the present disclosures, as discussed herein. In particular, the computer programs, when executed, enable the processor 2004 to perform the features in accordance with aspects of the present disclosures. Accordingly, such computer programs represent controllers of the computer system 2000.

In an aspect of the present disclosures where the method is implemented using software, the software may be stored in a computer program product and loaded into computer system 2000 using removable storage drive 2014, hard disk drive 2012, or the interface 2020. The control logic (software), when executed by the processor 2004, causes the processor 2004 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

FIG. 4 is a block diagram of various example system components, in accordance with an aspect of the present disclosure. FIG. 4 shows a communication system 2100 usable in accordance with the present disclosure. The communication system 2100 includes one or more accessors 2160, 2162 (also referred to interchangeably herein as one or more “users”) and one or more terminals 2142, 2166. In one aspect, data for use in accordance with aspects of the present disclosure is, for example, input and/or accessed by the one or more accessors 2160, 2162 via the one or more terminals 2142, 2166, such as personal computers (PCs), minicomputers, mainframe computers, microcomputers, telephonic devices, or wireless devices, such as personal digital assistants (“PDAs”) or a hand-held wireless devices coupled to a server 2143, such as a PC, minicomputer, mainframe computer, microcomputer, or other device having a processor and a repository for data and/or connection to a repository for data, via, for example, a network 2144, such as the Internet or an intranet, and couplings 2145, 2146, 2164. The couplings 2145, 2146, 2164 include, for example, wired, wireless, or fiberoptic links. In another example variation, the method and system in accordance with aspects of the present disclosure operate in a stand-alone environment, such as on a single terminal.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

1. A method by a security system, comprising:
receiving, from a requester, a request for accessing an access-controlled asset based on authentication information of an authorized user;
identifying a request location of the request;
identifying a current location of the authorized user;
determining whether the request location is substantially identical to the current location; and
granting the request in response to authenticating the authentication information and determining that the request location is substantially identical to the current location; or
denying the request in response to failure to authenticate the authentication information or determining that the request location is different than the current location.

2. The method of claim 1, further comprising, prior to receiving the request, receiving a registration request to register the user and the authentication information of the user for accessing the security system.

3. The method of claim 1, wherein identifying the current location of the user comprises receiving at least one of a visual confirmation of the user at the current location or a biometric confirmation of the user at the current location.

4. The method of claim 1, wherein the authentication information include at least one of a login, a password, a key card, a key fob, or a personal identification number.

5. The method of claim 1, further comprising, after granting the request:
detecting the authorized user being absent from the current location; and
suspending or terminating access to the access-controlled asset.

6. The method of claim 5, further comprising, after suspending the access for a threshold period, terminating the access.

7. The method of claim 1, further comprising receiving a multifactor authentication, wherein granting the request further comprises of validating the multifactor authentication.

8. A security device, comprising:
a memory including instructions; and
a processor configured to:
receive, from a requester, a request for accessing an access-controlled asset based on authentication information of an authorized user;
identify a request location of the request;
identify a current location of the authorized user;
determine whether the request location is substantially identical to the current location; and
grant the request in response to authenticating the authentication information and determining that the request location is substantially identical to the current location; or
deny the request in response to failure to authenticate the authentication information or determining that the request location is different than the current location.

9. The security device of claim 8, wherein the processor is further configured to, prior to receiving the request, receive a registration request to register the user and the authentication information of the user for accessing the security system.

10. The security device of claim 8, wherein identifying the current location of the user comprises receiving at least one of a visual confirmation of the user at the current location or a biometric confirmation of the user at the current location.

11. The security device of claim 8, wherein the authentication information include at least one of a login, a password, a key card, a key fob, or a personal identification number.

12. The security device of claim 8, wherein the processor is further configured to, after granting the request:
detect the user being absent from the current location; and
suspend or terminating access to the access-controlled asset.

13. The security device of claim 12, wherein the processor is further configured to, after suspending the access for a threshold period, terminate the access.

14. The security device of claim 8, wherein the processor is further configured to receive a multifactor authentication, wherein granting the request further comprises of validating the multifactor authentication.

15. A security system, comprising:
an access-controlled asset;
an authentication device configured to receive authentication information of an authorized user; and
a security device comprising:
a memory including instructions; and
a processor configured to:
receive, from a requester, a request for accessing the access-controlled asset based on the authentication information of the authorized user;
identify a request location of the request;
identify a current location of the authorized user;
determine whether the request location is substantially identical to the current location; and
grant the request in response to authenticating the authentication information and determining that the request location is substantially identical to the current location; or
deny the request in response to failure to authenticate the authentication information or determining that the request location is different than the current location.

16. The security system of claim 15, wherein the processor is further configured to, prior to receiving the request, receive a registration request to register the user and the authentication information of the user for accessing the security system.

17. The security system of claim 15, wherein identifying the current location of the user comprises receiving at least one of a visual confirmation of the user at the current location or a biometric confirmation of the user at the current location.

18. The security system of claim 15, wherein the authentication information include at least one of a login, a password, a key card, a key fob, or a personal identification number.

19. The security system of claim 15, wherein the processor is further configured to, after granting the request:
detect the user being absent from the current location; and
suspend or terminating access to the access-controlled asset.

20. The security system of claim 19, wherein the processor is further configured to, after suspending the access for a threshold period, terminate the access.

21. The security system of claim 8, wherein the processor is further configured to receive a multifactor authentication, wherein granting the request further comprises of validating the multifactor authentication.
